(19) United States
(12) Patent Application Publication
(10) Pub. No.: US 2024/0354943 A1
(43) Pub. Date: Oct. 24, 2024

(54) METHODS AND SYSTEMS FOR GENERATING ENHANCED FLUORESCENCE IMAGING DATA

(71) Applicant: Stryker Corporation, Kalamazoo, MI (US)

(72) Inventors: Bhavya Nishitkumar AJANI, Bengaluru (IN); Neveenkumar RANGASAMY, Bengaluru (IN); Swathi Swathi, Thrissur (IN); Tejas Haritsa VIDYASHANKAR KERESANTHE, Bengaluru (IN)

(73) Assignee: Stryker Corporation, Kalamazoo, MI (US)

(21) Appl. No.: 18/638,502

(22) Filed: Apr. 17, 2024

Related U.S. Application Data
(60) Provisional application No. 63/496,944, filed on Apr. 18, 2023.

(51) Int. Cl. G06T 7/00; G06T 5/50; G06T 7/194; G06V 10/56; G06V 10/60

(52) U.S. Cl. CPC G06T 7/0012; G06T 5/50; G06T 7/194; G06V 10/56; G06V 10/60; G06T 2207/10064; G06T 2207/20221; G06T 2207/30096; G06T 2207/30101; G06V 2201/07

(57) ABSTRACT

The present disclosure relates generally to medical imaging, and more specifically to machine-learning techniques to generate enhanced fluorescence images of a subject (e.g., to aid a surgery, to aid diagnosis and treatment of diseases). The system can receive a visible-light image of the subject; identify a background area in the visible-light image by providing the visible-light image to one or more trained machine-learning models; and enhance the fluorescence medical image by suppressing a plurality of pixels in the fluorescence medical image that correspond to the identified background area in the visible-light image relative to the rest of the pixels in the fluorescence medical image.

### CROSS-REFERENCE TO RELATED APPLICATIONS

This application claims the benefit of U.S. Provisional Application 63/496,944, filed on Apr. 18, 2023, the entire content of which is incorporated herein by reference for all purposes.

### FIELD

The present disclosure relates generally to medical imaging, and more specifically to machine-learning techniques to generate enhanced fluorescence images of a subject (e.g., to aid a surgery, to aid diagnosis and treatment of diseases).

### BACKGROUND

Medical systems, instruments, or tools are utilized pre-surgery, during surgery, or post-operatively for various purposes. Some of these medical tools may be used in what are generally termed endoscopic procedures or open field procedures. For example, endoscopy in the medical field allows internal features of the body of a patient to be viewed without the use of traditional, fully invasive surgery. Endoscopic imaging systems incorporate endoscopes to enable a surgeon to view a surgical site, and endoscopic tools enable minimally invasive surgery at the site. Such tools may be shaver-type devices, which mechanically cut bone and hard tissue, or radio frequency (RF) probes, which are used to remove tissue via ablation or to coagulate tissue to minimize bleeding at the surgical site, for example.

In endoscopic surgery, the endoscope is placed in the body at a location at which it is necessary to perform a surgical procedure. Other surgical instruments, such as the endoscopic tools mentioned above, can also be placed in the body at the surgical site. A surgeon views the surgical site through the endoscope in order to manipulate the tools to perform the desired surgical procedure. Some endoscopes are usable along with a camera head for the purpose of processing the images received by the endoscope. An endoscopic camera system typically includes a camera head connected to a camera control unit (CCU) by a cable. The CCU processes input image data received from the image sensor of the camera via the cable and then outputs the image data for display. The resolution and frame rates of endoscopic camera systems are ever increasing and each component of the system must be designed accordingly.

Another type of medical imager that can include a camera head connected to a CCU by a cable is an open-field imager. Open-field imagers can be used to image open surgical fields, such as for visualizing blood flow in vessels and related tissue perfusion during plastic, microsurgical, reconstructive, and gastrointestinal procedures.

During surgical procedures, fluorescence imaging can be used in many surgical procedures to assist in intraoperative decision-making. However, it may be impractical to administer fluorescent dyes (or fluorophores) at the ideal time, thus compromising the quality and usability of the resulting fluorescence images. For example, to visualize the biliary tree, indocyanine green (ICG) injection ideally should be performed 15 hours preoperatively such that, by the time of the surgery, the ICG in the hepatic tissue (i.e., the liver) is cleared and the ICG remains only in the biliary tree. But practically, administering the ICG 15 hours before a surgery is not possible as it would require overnight admission of the patient. Thus, surgeons instead generally inject ICG 15-60 minutes before the surgery, causing ICG to remain in the hepatic tissue and generating undesirable background signals in the fluorescence images. The subpar fluorescence images make it difficult for the surgeons to accurately identify the biliary tree during the surgery. Thus, it is desirable to develop techniques for enhancing fluorescence medical images by intelligently identifying background areas and/or areas of interest and suppressing the background signals relative to the signals from areas of interest to enhance visualization of objects of interest.

### SUMMARY

Disclosed herein are exemplary devices, apparatuses, systems, methods, non-transitory storage media, and computer program products for enhancing fluorescence medical images. The systems, devices, and methods may be used for imaging tissue of a subject, such as in endoscopic imaging procedures or open field surgical imaging procedures. Imaging may be performed pre-operatively, intra-operatively, post-operatively, and during diagnostic imaging sessions and procedures. The imaging methods may include or exclude insertion of an endoscopic imager into a lumen in the body or the use of an open field imaging system. The endoscopic imager may have been pre-inserted into the lumen prior to start of the imaging methods. The imaging methods may include or exclude an invasive surgical step. An exemplary method of enhancing a fluorescence medical image of a subject comprises: receiving a visible-light image and the fluorescence medical image of the subject; identifying a background area in at least one of the visible-light image and the fluorescence medical image by providing at least one of the visible-light image and the fluorescence medical image to one or more trained machine-learning models; and enhancing the fluorescence medical image by suppressing a plurality of pixels in the fluorescence medical image that correspond to the identified background area in at least one of the visible-light image and the fluorescence medical image relative to the rest of the pixels in the fluorescence medical image.

In some examples, the method further comprises displaying the enhanced fluorescence medical image. Displaying the enhanced fluorescence medical image can comprise: displaying the enhanced fluorescence medical image as a part of an intraoperative video stream. In some examples, the method further comprises displaying the visible-light image; and displaying the enhanced fluorescence medical image as an overlay on the displayed visible-light image.

In some examples, the method further comprises extracting the luminance channel of the visible-light image; colorizing the luminance channel of the visible-light image based on the enhanced fluorescence medical image; and displaying the colorized luminance channel of the visible-light image. Displaying the colorized luminance channel of the visible-light image can comprise displaying a first color for a first organ or tissue and displaying a second color for a second organ or tissue. In some examples, the method further comprises receiving a first user input indicative of a degree of enhancement; and suppressing the plurality of pixels in the fluorescence medical image based on the first user input. Identifying the background area can comprise: identifying one or more background objects in the visible-light image by providing the visible-light image to the one or more trained machine-learning models. Identifying the background area can comprise: identifying one or more background objects in the fluorescence image by providing the fluorescence image to the one or more trained machine learning models. The one or more background objects can comprise: an organ, a blood vessel, a connective tissue, a non-tumorous tissue, or fat. In some examples, the method further comprises receiving a second user input indicative of a selection of a background object of the one or more background objects; and suppressing the plurality of pixels in the fluorescence medical image based on the second user input. In some examples, identifying the background area comprises: identifying one or more objects of interest in the visible-light image by providing the visible-light image to the one or more trained machine-learning models. In some examples, identifying the background area comprises: identifying one or more objects of interest in the fluorescence image by providing the fluorescence image to the one or more trained machine learning models. The one or more objects of interest may comprise: a biliary structure, a tumor, an anastomotic end, a parathyroid gland, a lymph node, a limb drainage node, a thoracic duct, a renal vein, an artery, a ureter, a dysplastic tissue, a metaplastic tissue, or any combination thereof. In some examples, the method further comprises enhancing the fluorescence medical image by boosting a plurality of pixels in the fluorescence medical image that correspond to the one or more objects of interest in the visible-light image.

In some examples, the trained machine-learning model is configured to output a pixel-wise mask indicative of the identified background area. The pixel-wise mask can comprise a plurality of binary values, each binary value corresponding to a pixel in at least one of the visible-light image and the fluorescence medical image and indicative of whether the corresponding pixel depicts background or not. The pixel-wise mask may comprise a plurality of integer values, each integer value corresponding to a pixel in at least one of the visible-light image and the fluorescence medical image and indicative of an object that the corresponding pixel depicts.

In some examples, the visible-light image and the fluorescence image are captured during a surgery. In some examples, the visible-light image and the fluorescence image have been captured during a surgery, e.g. prior to start of the imaging methods. The surgery can comprise: a laparoscopic cholecystectomy surgery, a colorectal resection surgery, a total thyroidectomy surgery, a mastectomy surgery, a laparoscopic nephrectomy surgery, a laparoscopic liver resection surgery, a video assisted thoracoscopic surgery (VATS), a cystoscopy, a ureteroscopy, a transurethral resection of bladder tumor (TURBT), or a transurethral resection of the prostate (TURP).

In some examples, the visible-light image and the fluorescence image are sampled from one or more intraoperative videos. In some examples, the one or more trained machine-learning models are selected based on the surgery. In some examples, the visible-light image and the fluorescence image are captured using the same camera with different filters.

In some examples, the one or more trained machine-learning models comprise a convolutional neural network (CNN), a recurrent neural network (RNN), a diffusion model, a transformer Network, or any combination thereof. The one or more machine-learning models can be trained using a plurality of training images, each training image including one or more annotations related to a background object or an object of interest. In some examples, at least a subset of the plurality of training images comprise one or more annotations related to a pattern associated with a microstructure of a tissue.

An exemplary system for enhancing a fluorescence medical image of a subject comprises: one or more processors; one or more memories; and one or more programs, wherein the one or more programs are stored in the one or more memories and configured to be executed by the one or more processors, the one or more programs including instructions for: receiving a visible-light image of the subject and the fluorescence medical image; identifying a background area in at least one of the visible-light image and the fluorescence medical image by providing at least one of the visible-light image and the fluorescence medical image to one or more trained machine-learning models; and enhancing the fluorescence medical image by suppressing a plurality of pixels in the fluorescence medical image that correspond to the identified background area in at least one of the visible-light image and the fluorescence medical image relative to the rest of the pixels in the fluorescence medical image.

In some examples, the one or more programs further include instructions for displaying the enhanced fluorescence medical image. Displaying the enhanced fluorescence medical image can comprise: displaying the enhanced fluorescence medical image as a part of an intraoperative video stream. In some examples, the one or more programs further include instructions for displaying the visible-light image; and displaying the enhanced fluorescence medical image as an overlay on the displayed visible-light image.

In some examples, the one or more programs further include instructions for extracting the luminance channel of the visible-light image; colorizing the luminance channel of the visible-light image based on the enhanced fluorescence medical image; and displaying the colorized luminance channel of the visible-light image. Displaying the colorized luminance channel of the visible-light image can comprise displaying a first color for a first organ or tissue and displaying a second color for a second organ or tissue. In some examples, the one or more programs further include instructions for receiving a first user input indicative of a degree of enhancement; and suppressing the plurality of pixels in the fluorescence medical image based on the first user input. Identifying the background area can comprise: identifying one or more background objects in the visible-light image by providing the visible-light image to the one or more trained machine-learning models. Identifying the background area can comprise: identifying one or more background objects in the fluorescence image by providing the fluorescence image to the one or more trained machine learning models. The one or more background objects can comprise: an organ, a blood vessel, a connective tissue, a non-tumorous tissue, or fat. In some examples, the one or more programs further include instructions for receiving a second user input indicative of a selection of a background object of the one or more background objects; and suppressing the plurality of pixels in the fluorescence medical image based on the second user input. In some examples, identifying the background area comprises: identifying one or more objects of interest in the visible-light image by providing the visible-light image to the one or more trained machine-learning models. In some examples, identifying the background area comprises: identifying one or more objects of interest in the fluorescence image by providing the fluorescence image to the one or more trained machine learning models. The one or more objects of interest may comprise: a biliary structure, a tumor, an anastomotic end, a parathyroid gland, a lymph node, a limb drainage node, a thoracic duct, a renal vein, an artery, a ureter, a dysplastic tissue, a metaplastic tissue, or any combination thereof. In some examples, the one or more programs further include instructions for enhancing the fluorescence medical image by boosting a plurality of pixels in the fluorescence medical image that correspond to the one or more objects of interest in the visible-light image.

In some examples, the trained machine-learning model is configured to output a pixel-wise mask indicative of the identified background area. The pixel-wise mask can comprise a plurality of binary values, each binary value corresponding to a pixel in at least one of the visible-light image and the fluorescence medical image and indicative of whether the corresponding pixel depicts background or not. The pixel-wise mask may comprise a plurality of integer values, each integer value corresponding to a pixel in at least one of the visible-light image and the fluorescence medical image and indicative of an object that the corresponding pixel depicts.

In some examples, the visible-light image and the fluorescence image are captured during a surgery. The surgery can comprise: a laparoscopic cholecystectomy surgery, a colorectal resection surgery, a total thyroidectomy surgery, a mastectomy surgery, a laparoscopic nephrectomy surgery, a laparoscopic liver resection surgery, a video assisted thoracoscopic surgery (VATS), a cystoscopy, a ureteroscopy, a transurethral resection of bladder tumor (TURBT), or a transurethral resection of the prostate (TURP).

In some examples, the visible-light image and the fluorescence image are sampled from one or more intraoperative videos. In some examples, the one or more trained machine-learning models are selected based on the surgery. In some examples, the visible-light image and the fluorescence image are captured using the same camera with different filters.

In some examples, the one or more trained machine-learning models comprise a convolutional neural network (CNN), a recurrent neural network (RNN), a diffusion model, a transformer Network, or any combination thereof. The one or more machine-learning models can be trained using a plurality of training images, each training image including one or more annotations related to a background object or an object of interest. In some examples, at least a subset of the plurality of training images comprise one or more annotations related to a pattern associated with a microstructure of a tissue.

A non-transitory computer-readable storage medium stores one or more programs, the one or more programs comprising instructions, which when executed by one or more processors of an electronic device, cause the electronic device to perform any of methods described herein. A computer program product comprising software code portions comprising instructions, which when executed by one or more processors of an electronic device, cause the electronic device to perform any of the methods described herein.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The invention will now be described, by way of example only, with reference to the accompanying drawings, in which:

FIG. 1A is an illustration of an endoscopic camera system, according to some examples;

FIG. 1B is a diagram of a portion of the endoscopic camera system of FIG. 1A and a target object for imaging, according to some examples;

FIG. 2 illustrates a schematic view of a system for illumination and imaging according to some examples;

FIG. 3 is a block diagram of an imaging system, according to some examples;

FIGS. 4A and 4B illustrate a comparison of an exemplary visible-light image and an exemplary fluorescence image captured during laparoscopic cholecystectomy, in accordance withs some examples;

FIG. 5 illustrates an exemplary method for enhancing a fluorescence medical image of a subject, according to some examples;

FIG. 6 illustrates an exemplary process of selective enhancement of fluorescence images based on anatomy, in accordance with some examples;

FIGS. 7A-7C illustrate a comparison of exemplary images, in accordance with some examples;

FIGS. 8A-8E illustrate a comparison of exemplary images, in accordance with some examples;

FIG. 9 illustrates an exemplary method for enhancing a fluorescence medical image of a subject, according to some examples;

FIG. 10 illustrates an exemplary process of selective enhancement of fluorescence images based on machine learning analysis of fluorescence images, in accordance with some examples;

FIG. 11 illustrates an exemplary fluorescence image and fluorescence patterns that correspond to micro-structural patterns of different organs, in accordance with some examples;

FIG. 12 illustrates a visible-light image with color coded organs according to fluorescence signals associated with the organs, in accordance with some examples.

### DETAILED DESCRIPTION

Reference will now be made in detail to implementations and various aspects and variations of systems and methods described herein. Although several exemplary variations of the systems and methods are described herein, other variations of the systems and methods may include aspects of the systems and methods described herein combined in any suitable manner having combinations of all or some of the aspects described. Examples will now be described more fully hereinafter with reference to the accompanying drawings; however, they may be embodied in different forms and should not be construed as limited to the examples set forth herein. Rather, these examples are provided so that this disclosure will be thorough and complete, and will fully convey exemplary implementations to those skilled in the art.

Disclosed herein are exemplary devices, apparatuses, systems, methods, and non-transitory storage media for enhancing fluorescence medical images. The systems, devices, and methods may be used for imaging tissue of a subject, such as in endoscopic imaging procedures or open field surgical imaging procedures. Imaging may be performed pre-operatively, intra-operatively, post-operatively, and during diagnostic imaging sessions and procedures. The imaging methods may include or exclude insertion of an endoscopic imager into a lumen in the body or the use of an open field imaging system. The imaging methods may include or exclude an invasive surgical step.

During surgical procedures, fluorescence imaging can be used to assist in intraoperative decision-making. For example, ICG fluorescence imaging is widely used in various surgical procedures to help surgeons identify vital structures. ICG is a florescent dye that can be injected into systemic circulation via intravenous route or can be injected locally into a tissue without any significant side effects. When injected intravenously, the dye binds with plasma proteins and remains in the systemic circulation. The dye is removed from circulation by the liver, which excretes the dye along with the bile. After injection, when illuminated by light with an appropriate excitation wavelength, ICG emits fluorescence in the near infra-red (NIR) spectrum, which can be detected by an NIR imaging camera. The resulting fluorescence image (i.e., NIR image) thus captured can be displayed in the monitor allowing identification of anatomical structures where the dye is present. It should be understood that other fluorescent imaging agents (e.g., OTL-38) fall within the scope of this disclosure. It should also be understood that as used herein, fluorescence imaging, fluorescence image, etc. may refer to fluorescence in the near infra-red (NIR) spectrum, ultra-violet (UV) spectrum, and/or any other medically relevant fluorescence imaging spectra.

Fluorescence images can be particularly useful relative to visible-light images (e.g., non-fluorescence images that may show how objects appear to the naked eye) in certain surgical contexts. For example, in laparoscopic cholecystectomies, a visible-light image may be sufficient for identifying anatomical structures such as the liver and the gallbladder, but insufficient for clearly visualizing the biliary tree, which is obscured in fat and tissue. ICG imaging can be leveraged to identify the biliary tree in a separate fluorescence image to prevent inadvertent injury to the biliary structures.

However, it may be impractical to administer ICG at the ideal time, thus compromising the quality and usability of the resulting fluorescence images. For example, to visualize the biliary tree, ICG injection ideally should be performed 15 hours preoperatively such that, by the time of the surgery, the ICG in the hepatic tissue is cleared and it remains only in the biliary tree. But practically, this is not possible as it would require overnight admission of the patient. Thus, surgeons instead generally inject ICG 15-60 minutes before the surgery, causing ICG to remain in the hepatic tissue and generating undesirable background signals in the fluorescence images.

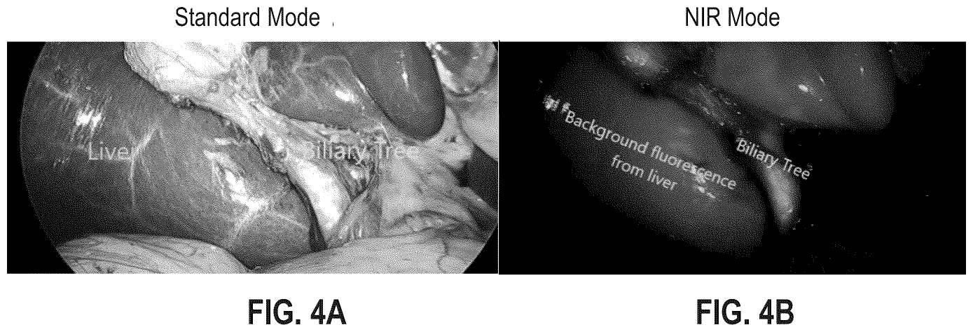

FIGS. 4A-B illustrate exemplary deficiencies of visible-light images and fluorescence images in the surgical context, according to some examples. FIG. 4A is a visible-light image depicting an operative view of a laparoscopic cholecystectomy surgery, and FIG. 4B is a fluorescence image depicting the same operative view. As shown, FIG. 4A may be sufficient for identifying anatomical structures such as the liver and the gallbladder, but insufficient for clearly visualizing the biliary tree, which is obscured in fat and tissue. In contrast, in FIG. 4B, the biliary tree is visible due to the ICG, but the background signals from the liver interfere with the proper visualization of the biliary tree.

The subpar fluorescence images such as FIG. 4B make it difficult for surgeons to accurately identify the biliary tree during the surgery. For example, during the dissection of Calot's triangle, the surgeon may review the operating location in the fluorescence mode and may need to tune the cut-off threshold for displaying the fluorescence signal to try to eliminate the background signal. Many times, the intensity of the fluorescence signal from the biliary structures is either the same or sometimes even lower than that of the liver. Accordingly, the tuning may cause the whole biliary structures to disappear or highlight only the liver instead of the biliary structures, thus making the entire fluorescence system ineffective during surgery.

Examples of the present disclosure comprise an image processing pipeline for enhancing fluorescence medical images. In some examples, an exemplary system (e.g., one or more electronic devices) receives a visible-light image of the subject and identifies a background area in the visible-light image by providing the visible-light image to one or more trained machine-learning models. The background area can refer to regions of the image that are not areas of interest. The background area may be easy to identify on the white light channel (i.e., in the visible-light image). The background can also be identified by inputting a fluorescent image into to one or more trained machine learning models trained to identify a background area and/or one or more objects of interest based on at least one fluorescent pattern associated with a cellular structure of an organ and/or tissue or tissue type. The system then enhances the fluorescence medical image by suppressing a plurality of pixels in the fluorescence medical image that correspond to the identified background area in the visible-light image relative to the rest of the pixels in the fluorescence medical image. The system can do so by reducing the amplitude of pixels corresponding to the background area (e.g., background organs such as the liver). Additionally or alternatively, the system can do so by boosting the amplitude of pixels corresponding to the areas or the objects of interest (e.g., the biliary tree). In some examples, the model may be configured to receive a plurality of images including the visible-light image. In some examples, the model may be configured to receive both the visible-light image and the fluorescence medical image. In some examples, the model may output the enhanced fluorescence medical image directly.

Examples of the present disclosure provide numerous technical advantages. For example, the exemplary system can intelligently identify fluorescence signals corresponding to the background v. the area of interest (e.g., based on a corresponding visible-light image and/or fluorescence image), and furthermore automatically and selectively suppress unwanted background fluorescence signals from background tissues and enhance the fluorescence signals from the areas or objects of interest. In some examples, a user (e.g., a surgeon) can choose the anatomical region from which the fluorescence signals should be suppressed and/or the anatomical region from which the fluorescence signals should be boosted. In some examples, the user can specify the degree of enhancement. Accordingly, examples of the present disclosure can eliminate the need for manual tuning of the cut-off threshold for displaying the fluorescence signal by surgeons to highlight the area of interest intraoperatively. In fact, examples of the present disclosure can enhance visualization of the objects of interest even in situations where the objects of interest have lower fluorescence intensity than the background, because the present techniques are not based on amplitude of the fluorescence signals, but rather based on intelligent identification of the relevant anatomical structures. Examples of the present disclosure can also eliminate the need for switching between a fluorescence visualization mode and a standard white-light visualization mode during surgical procedures.

Techniques of the present disclosure can be used in connection with, such as during, a wide variety of surgical procedures to make the surgical procedures easier to perform and prevent inadvertent injury to vital structures. In many surgeries, the fluorescence dye (e.g., ICG, Pafolacianine, Hexaminolevulinate, Pudexacianinium) is percolated into surrounding tissue along with the anatomical structure of interest, thus generating fluorescence signals in the surrounding or background tissue. Techniques of the present disclosure may be applied to suppress such unwanted fluorescence signals to enhance visualization of anatomical structures of interest, such as in laparoscopic cholecystectomy (e.g., to identify biliary structures), in colorectal resection (e.g., to assess the perfusion of the anastomotic ends), in total thyroidectomy (e.g., to identify parathyroid glands), in mastectomy (e.g., to identify sentinel lymph nodes and to assess the perfusion of flaps), in axillary reverse mapping (e.g., to preserve limb drainage nodes), in laparoscopic nephrectomies (e.g., to identify renal vein), in laparoscopic liver resection (e.g., to identify hepatic artery), surgeries in thoracic duct (e.g., to identify thoracic duct, lung cancers), in cystoscopy and transurethral resection of bladder tumor (TURBT) (e.g., to identify bladder cancers), in pelvic surgeries (e.g., to identify ovarian cancers) etc.

After the fluorescence medical image is enhanced, the system can display the enhanced fluorescence medical image. For example, the system can display the enhanced fluorescence medical image as a part of an intraoperative video stream (e.g., in real time or with minimal delay). As another example, the system can display the visible-light image and display the enhanced fluorescence medical image as an overlay on the displayed visible-light image. In some examples, the system can extract the luminance channel of the visible-light image, colorize the luminance channel of the visible-light image based on the enhanced fluorescence medical image, and display the colorized luminance channel of the visible-light image. In some examples, fluorescence signal from different organs or different tissues can be enhanced with different colors.

In some examples, the system can provide a recommendation related to the surgical procedure based on the enhanced fluorescence medical image. The recommendation can be related to navigating a surgical instrument or operating a surgical tool. The recommendation can be an indication of an anatomical structure to operate on or to avoid. The recommendation can be related to administration of a particular treatment. The recommendation can be related to identification of a high-risk area or a potential complication. In some examples, the recommendation is provided during the surgery such that the surgeon can alter the course of action in real time.

In some examples, the enhanced fluorescence medical image can be provided (e.g., displayed) to a medical practitioner, who can review the image to identify, recommend, and/or administer a treatment or some other course of action to the patient pre-surgery, during surgery, or post-operatively. In some examples, the enhanced fluorescence image can be provided to a computer-based system, which processes the image to identify, recommend, and/or administer a treatment or some other course of action to the patient. For example, the system can provide the enhanced fluorescence medical image to a classification model to automatically identify one or more complications. Based on the identified issue, a treatment or some other course of action can be automatically recommended (e.g., via one or more graphical user interfaces). The treatment can also be automatically administered, for example, by a medical device (e.g., a surgical robot) based on the automatically recommended treatment.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

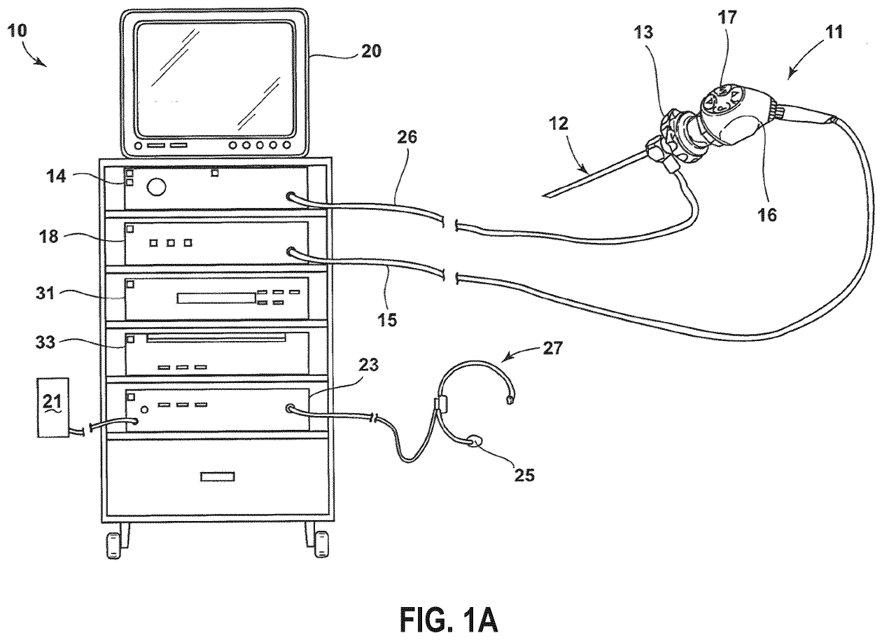

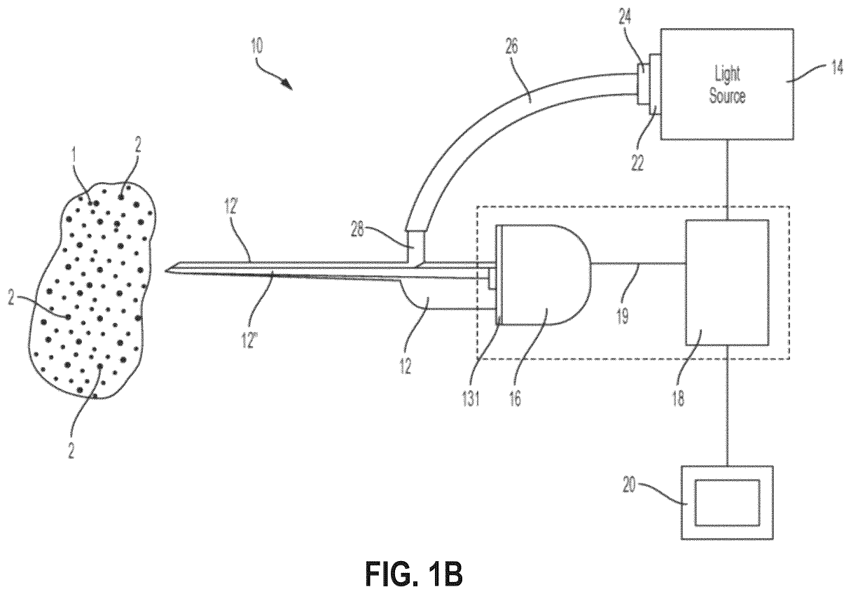

FIG. 1A shows an example of an endoscopic imaging system 10, which includes a scope assembly 11 which may be utilized in endoscopic procedures. The scope assembly 11 incorporates an endoscope or scope 12 which is coupled to a camera head 16 by a coupler 13 located at the distal end of the camera head 16. Light is provided to the scope by a light source 14 via a light guide 26, such as a fiber optic cable. The camera head 16 is coupled to a camera control unit (CCU) 18 by an electrical cable 15. The CCU 18 is connected to, and communicates with, the light source 14. Operation of the camera 16 is controlled, in part, by the CCU 18. The cable 15 conveys video image and/or still image data from the camera head 16 to the CCU 18 and may convey various control signals bi-directionally between the camera head 16 and the CCU 18.

A control or switch arrangement 17 may be provided on the camera head 16 for allowing a user to manually control various functions of the system 10, which may include switching from one imaging mode to another, as discussed further below. Voice commands may be input into a microphone 25 mounted on a headset 27 worn by the practitioner and coupled to the voice-control unit 23. A hand-held control device 29, such as a tablet with a touch screen user interface or a PDA, may be coupled to the voice control unit 23 as a further control interface. In the illustrated example, a recorder 31 and a printer 33 are also coupled to the CCU 18. Additional devices, such as an image capture and archiving device, may be included in the system 10 and coupled to the CCU 18. Video image data acquired by the camera head 16 and processed by the CCU 18 is converted to images, which can be displayed on a monitor 20, recorded by recorder 31, and/or used to generate static images, hard copies of which can be produced by the printer 33.

FIG. 1B shows an example of a portion of the endoscopic system 10 being used to illuminate and receive light from an object 1, such as a surgical site of a patient. The object 1 may include fluorescent markers 2, for example, as a result of the patient being administered a fluorescence imaging agent. The fluorescent markers 2 may comprise, for example, indocyanine green (ICG).

The light source 14 can generate visible illumination light (such as any combination of red, green, and blue light) for generating visible (e.g., white light) images of the target object 1 and, in some examples, can also produce fluorescence excitation illumination light for exciting the fluorescent markers 2 in the target object for generating fluorescence images. In some examples, the light source 14 can produce fluorescence excitation illumination light for exciting autofluorescence in the target object for generating fluorescence images, additionally or alternatively to light for exciting the fluorescent markers. Illumination light is transmitted to and through an optic lens system 22 which focuses light onto a light pipe 24. The light pipe 24 may create a homogeneous light, which is then transmitted to the fiber optic light guide 26. The light guide 26 may include multiple optic fibers and is connected to a light post 28, which is part of the endoscope 12. The endoscope 12 includes an illumination pathway 12′ and an optical channel pathway 12″.

The endoscope 12 may include a notch filter 131 that allows some or all (preferably, at least 80%) of fluorescence emission light (e.g., in a wavelength range of 830 nm to 870 nm) emitted by fluorescence markers 2 in the target object 1 to pass therethrough and that allows some or all (preferably, at least 80%) of visible light (e.g., in the wavelength range of 400 nm to 700 nm), such as visible illumination light reflected by the target object 1, to pass therethrough, but that blocks substantially all of the fluorescence excitation light (e.g., infrared light having a wavelength of 808 nm) that is used to excite fluorescence emission from the fluorescent marker 2 in the target object 1. The notch filter 131 may have an optical density of OD5 or higher. In some examples, the notch filter 131 can be located in the coupler 13.

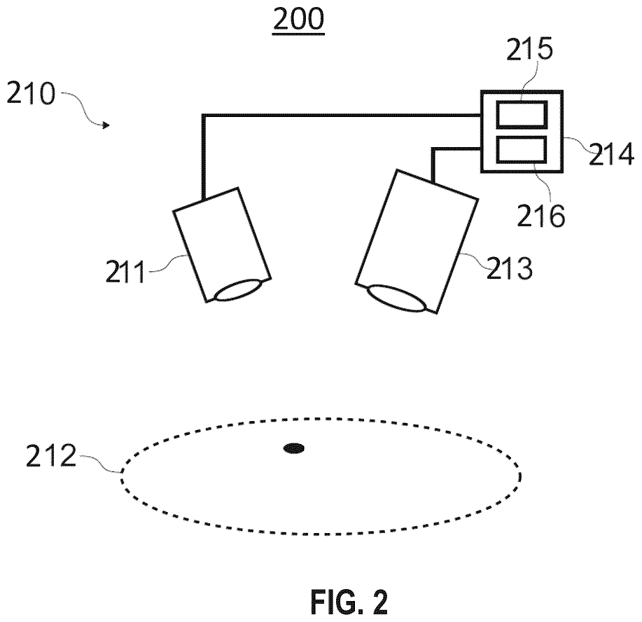

FIG. 2 illustrates an exemplary open field imaging system in accordance with some examples. FIG. 2 illustrates a schematic view of an illumination and imaging system 210 that can be used in open field surgical procedures. As may be seen therein, the system 210 may include an illumination module 211, an imaging module 213, and a video processor/illuminator (VPI) 214. The VPI 214 may include an illumination source 215 to provide illumination to the illumination module 211 and a processor assembly 216 to send control signals and to receive data about light detected by the imaging module 213 from a target 212 illuminated by light output by the illumination module 211. In one variation, the video processor/illuminator 214 may comprise a separately housed illumination source 215 and the processor assembly 216. In one variation, the video processor/illuminator 214 may comprise the processor assembly 216 while one or more illumination sources 215 are separately contained within the housing of the illumination module 211. The illumination source 215 may output light at different waveband regions, e.g., white (RGB) light, excitation light to induce fluorescence in the target 212, a combination thereof, and so forth, depending on characteristics to be examined and the material of the target 212. Light at different wavebands may be output by the illumination source 215 simultaneously, sequentially, or both. The illumination and imaging system 210 may be used, for example, to facilitate medical (e.g., surgical) decision making e.g., during a surgical procedure. The target 212 may be a topographically complex target, e.g., a biological material including tissue, an anatomical structure, other objects with contours and shapes resulting in shadowing when illuminated, and so forth. The VPI 214 may record, process, display, and so forth, the resulting images and associated information.

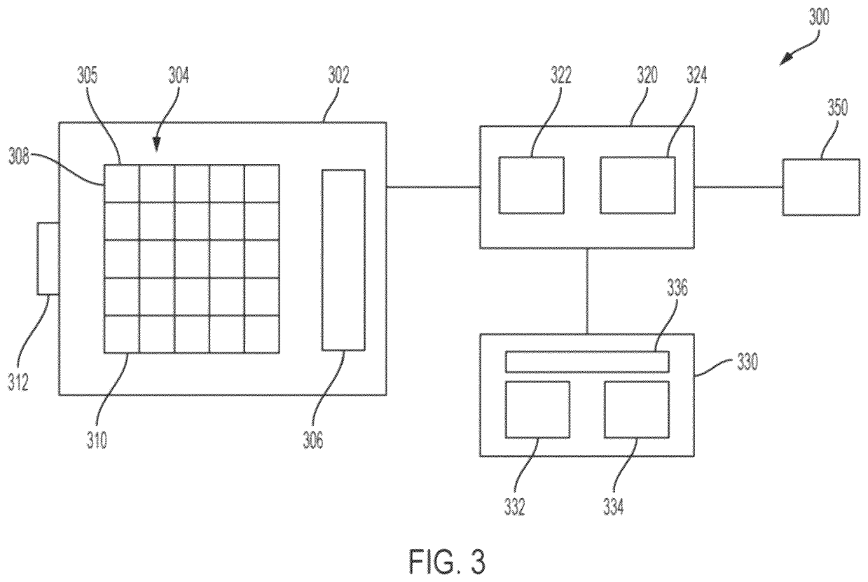

FIG. 3 schematically illustrates an exemplary imaging system 300 that employs an electronic imager 302 to generate images (e.g., still and/or video) of a target object, such as a target tissue of a patient, according to some examples. The imager 302 may be a rolling shutter imager (e.g., CMOS sensors) or a global shutter imager (e.g., CCD sensors). System 300 may be used, for example, for the endoscopic imaging system 10 of FIG. 1A. The imager 302 includes a CMOS sensor 304 having an array of pixels 305 arranged in rows of pixels 308 and columns of pixels 310. The imager 302 may include control components 306 that control the signals generated by the CMOS sensor 304. Examples of control components include gain circuitry for generating a multi-bit signal indicative of light incident on each pixel of the sensor 304, one or more analog-to-digital converters, one or more line drivers to act as a buffer and provide driving power for the sensor 304, row circuitry, and timing circuitry. A timing circuit may include components such as a bias circuit, a clock/timing generation circuit, and/or an oscillator. Row circuitry may enable one or more processing and/or operational tasks such as addressing rows of pixels 308, addressing columns of pixels 310, resetting charge on rows of pixels 308, enabling exposure of pixels 305, decoding signals, amplifying signals, analog-to-digital signal conversion, applying timing, read out and reset signals and other suitable processes or tasks. Imager 302 may also include a mechanical shutter 312 that may be used, for example, to control exposure of the image sensor 304 and/or to control an amount of light received at the image sensor 304.

One or more control components may be integrated into the same integrated circuit in which the sensor 304 is integrated or may be discrete components. The imager 302 may be incorporated into an imaging head, such as camera head 16 of system 10.

One or more control components 306, such as row circuitry and a timing circuit, may be electrically connected to an imaging controller 320, such as camera control unit 18 of system 10. The imaging controller 320 may include one or more processors 322 and memory 324. The imaging controller 320 receives imager row readouts and may control readout timings and other imager operations, including mechanical shutter operation. The imaging controller 320 may generate image frames, such as video frames from the row and/or column readouts from the imager 302. Generated frames may be provided to a display 350 for display to a user, such as a surgeon.

The system 300 in this example includes a light source 330 for illuminating a target scene. The light source 330 is controlled by the imaging controller 320. The imaging controller 320 may determine the type of illumination provided by the light source 330 (e.g., white light, fluorescence excitation light, or both), the intensity of the illumination provided by the light source 330, and or the on/off times of illumination in synchronization with rolling shutter operation. The light source 330 may include a first light generator 332 for generating light in a first wavelength and a second light generator 334 for generating light in a second wavelength. In some examples, the first light generator 332 is a white light generator, which may be comprised of multiple discrete light generation components (e.g., multiple LEDs of different colors), and the second light generator 334 is a fluorescence excitation light generator, such as a laser diode.

The light source 330 includes a controller 336 for controlling light output of the light generators. The controller 336 may be configured to provide pulse width modulation of the light generators for modulating intensity of light provided by the light source 330, which can be used to manage over-exposure and under-exposure. In some examples, nominal current and/or voltage of each light generator remains constant and the light intensity is modulated by switching the light generators (e.g., LEDs) on and off according to a pulse width control signal. In some examples, a PWM control signal is provided by the imaging controller 336. This control signal can be a waveform that corresponds to the desired pulse width modulated operation of light generators.

The imaging controller 320 may be configured to determine the illumination intensity required of the light source 330 and may generate a, e.g. PWM, signal that is communicated to the light source 330. In some examples, depending on the amount of light received at the sensor 304 and the integration times, the light source may be pulsed at different rates to alter the intensity of illumination light at the target scene. The imaging controller 320 may determine a required illumination light intensity for a subsequent frame based on an amount of light received at the sensor 304 in a current frame and/or one or more previous frames. In some examples, the imaging controller 320 is capable of controlling pixel intensities via PWM of the light source 330 (to increase/decrease the amount of light at the pixels), via operation of the mechanical shutter 312 (to increase/decrease the amount of light at the pixels), and/or via changes in gain (to increase/decrease sensitivity of the pixels to received light). In some examples, the imaging controller 320 primarily uses PWM of the illumination source for controlling pixel intensities while holding the shutter open (or at least not operating the shutter) and maintaining gain levels. The controller 320 may operate the shutter 312 and/or modify the gain in the event that the light intensity is at a maximum or minimum and further adjustment is needed.

### Enhancing Fluorescence Imaging Data

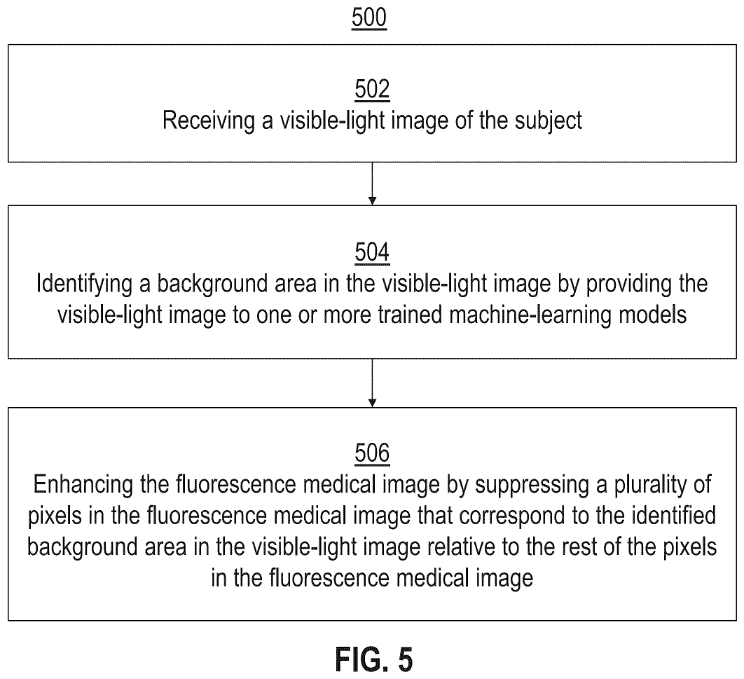

FIG. 5 illustrates an exemplary method 500 for enhancing a fluorescence medical image of a subject, according to some examples. In some examples, the fluorescence medical image may be an autofluorescence image. Process 500 is performed, for example, using one or more electronic devices implementing a software platform. In some examples, process 500 is performed using a client-server system, and the blocks of process 500 are divided up in any manner between the server and one or more client devices. In some examples, process 500 is performed using only a client device or only multiple client devices. In process 500, some blocks are, optionally, combined, the order of some blocks is, optionally, changed, and some blocks are, optionally, omitted. In some examples, additional steps may be performed in combination with the process 500. Accordingly, the operations as illustrated (and described in greater detail below) are exemplary by nature and, as such, should not be viewed as limiting.

At block 502, an exemplary system (e.g., one or more electronic devices) receives a visible-light image of the subject. The visible-light image can be any non-fluorescence image that depicts the same subject as the fluorescence medical image to be enhanced. The visible-light image may be a bright-light or white-light image (e.g., an RGB image) that shows how objects appear to the naked eye and may or may not include additional pre-processing. The visible-light image may be captured in the same surgery and/or around the same time as the fluorescence image to be enhanced. The visible-light image and the fluorescence image may be captured with the same camera, e.g. with different illumination sources, and e.g. captured on one or more image channels (e.g., white-light channel(s) v. fluorescence channel(s)); accordingly, the two images depict an identical scene. The visible-light image and/or the fluorescence image may be sampled from one or more intraoperative videos.

The surgery during which the visible-light image and/or the fluorescence image are captured may include any surgical procedure, including endoscopic procedures and open field procedures. The endoscope may have been pre-inserted into a body lumen prior to start of the method 500. In some examples, the surgery includes: a laparoscopic cholecystectomy surgery, a colorectal resection surgery, a total thyroidectomy surgery, a mastectomy surgery, a laparoscopic nephrectomy surgery, a laparoscopic liver resection surgery, a video assisted thoracoscopic surgery (VATS), a cystoscopy, a ureteroscopy, a transurethral resection of bladder tumor (TURBT), or a transurethral resection of the prostate (TURP).

At block 504, the system identifies a background area in the visible-light image by providing the visible-light image to one or more trained machine-learning models. The machine-learning models may include one or more machine-learning models configured to identify one or more background objects in the input image, one or more machine-learning models configured to identify one or more areas or objects of interest in the input image, or any combination thereof, as discussed below.

The system can provide the visible-light image to one or more trained machine-learning models configured to identify one or more background objects in an input image. The background objects may be surgery-dependent and include objects in the image that are not of interest to the user (e.g., a surgeon) and therefore should be suppressed relative to the objects of interest depicted in the image. In some examples, the one or more background objects can comprise: an organ, a blood vessel, a connective tissue, a non-tumorous tissue, or fat.

Alternatively, or additionally, the system can provide the visible-light image to one or more trained machine-learning models configured to identify one or more objects of interest in an input image. The objects of interest may be surgery-dependent and include objects in the image that are useful/important to the user (e.g., a surgeon) and therefore should be made more visually distinguishable. In some examples, the one or more objects of interest can comprise: a biliary structure, a tumor, an anastomotic end, a parathyroid gland, a lymph node, a limb drainage node, a thoracic duct, a renal vein, an artery, or any combination thereof.

The one or more machine-learning models can include a model that is configured to detect a single object (e.g., a single background object, a single object of interest), a model that is configured to detect multiple objects (e.g., background object(s), object(s) of interest, or a combination thereof), or a combination thereof. As one example, an exemplary machine-learning model can be trained to detect a single predefined background object. The model receives an input image and identifies the pixels in the image that correspond to the background object. The model may assign a first value (e.g., 1) to those identified pixels while assigning a second value (e.g., 0) to the rest of the pixels. As a second example, an exemplary machine-learning model can be trained to detect multiple predefined objects. The model receives an input image and identifies the pixels in the image that correspond to those objects. The model may assign a first value (e.g., 1) to those identified pixels while assigning a second value (e.g., 0) to the rest of the pixels. Alternatively, the model may assign different integer values to different objects. For example, the model may assign a first value (e.g., 1) to pixels corresponding to a first object, a second value (e.g., 2) to pixels corresponding to a second object, . . . while assigning a different value (e.g., 0) to the pixels that do not correspond to any identified object in the image.

Based on the detected background objects (which are part of the background area) and/or the detected objects of interest, the system can obtain a pixel-wise mask indicative of the identified background area. For example, the pixel-wise mask can comprise a plurality of binary values, each binary value corresponding to a pixel in the visible-light image and indicative of whether the corresponding pixel depicts background or not (e.g., 0 representing the background and non-zero representing non-background). As another example, the pixel-wise mask can comprise a plurality of integer values, each integer value corresponding to a pixel in the visible-light image and indicative of an object that the corresponding pixel depicts (e.g., 1 representing a first object, 2 representing a second object, etc.).

In some examples, the one or more trained machine-learning models are selected based on the surgery during which the visible-light image is taken. Different surgeries may involve different objects of interest. For example, a blood vessel may be considered an object of interest to be enhanced in one surgery, but a background object to be suppressed in a different surgery. Accordingly, depending on the surgery and/or surgeon preferences, the system can select different model(s) based on what is considered to be background in the context of that surgery.

The machine-learning models may comprise any machine-learning models that can be configured to detect an object in an input image. In some examples, the machine-learning models can comprise a binary and/or multi-class semantic segmentation model, a panoptic semantic segmentation model, regression model for predicting contours of objects, dense semantic regression model for predicting pixel-wise level or fluorescence modulation, an object detection model detecting object contours, or any combination thereof. In some examples, the machine-learning models can comprise convolutional neural networks (CNNs), recurrent neural networks (RNNs), diffusion models, transformer networks, reinforcement learning or any combination thereof. In some examples, the models can be based on any of the deep learning architectures such as CNNs, region-based CNNs (R-CNNs), pyramidal pooling or long short-term memory (LSTM) models, transformers, or any combination thereof.

The machine-learning models can be trained using a plurality of training images. Each training image may include one or more annotations related to a background object/area and/or an object/area of interest. During training, a model can be configured to receive a training image and identify pixels corresponding to an object. The pixels can be compared against the annotations (i.e., the ground truth), and the model can be updated based on the comparison. In some examples, the models may be pre-trained using a first training dataset and then fine-tuned using a second training dataset. In some examples, the models may be fine-tuned periodically or on an ongoing basis using new training datasets.

At block 506, the system enhances the fluorescence medical image. Specifically, the system can suppress a plurality of pixels in the fluorescence medical image that correspond to the identified background area in the visible-light image relative to the rest of the pixels in the fluorescence medical image. The system can do so by, for example, reducing the amplitude of those pixels corresponding to the identified background area. The reduction can be done by multiplying the amplitude of each pixel with 0 or a value lower than 1. Alternatively or additionally, the system can do so by boosting the pixels that do not correspond to the identified background area (e.g., the pixels corresponding to the objects of interest). The boosting can be done by multiplying the amplitude of each pixel with a value higher than 1, by applying a gain function, or a combination thereof, to make the pixel appear more visually distinguishable (e.g., brighter).

The system may allow a user (e.g., a surgeon) to indicate the degree of enhancement (e.g., a percentage). For example, the system can provide a user interface control (e.g., a slide bar, a text field, a button, a checkbox) for the user to indicate the desired degree of enhancement. Based on the input, the system can then suppress the plurality of pixels in the fluorescence medical image that correspond to the identified background area in the visible-light image relative to the rest of the pixels in the fluorescence medical image (e.g., by reducing amplitude of the background pixels, by increasing amplitude of pixels corresponding to areas of interest, or both).

The system may also allow a user to indicate which background object(s) to suppress and/or which object(s) of interest to boost. For example, the system can display the visible-light image, indicate the identified objects in the visible-light image (e.g., via shadings, via contours), and provide a user interface control (e.g., a slide bar, a text field, a button, a checkbox) for the user to select an object to suppress or boost.

After the fluorescence medical image is enhanced, the system can display the enhanced fluorescence medical image. For example, the system can display the enhanced fluorescence medical image as a part of an intraoperative video stream (e.g., in real time or with minimal delay). The system can display the visible-light image and display the enhanced fluorescence medical image as an overlay on the displayed visible-light image. In some examples, the system can extract the luminance channel of the visible-light image, colorize the luminance channel of the visible-light image based on the enhanced fluorescence medical image; and display the colorized luminance channel of the visible-light image. In some examples, fluorescence signal from different organs or different tissues can be enhanced with different colors.

In some examples, the system can provide a recommendation related to the surgical procedure based on the enhanced fluorescence medical image. The recommendation can be related to navigating a surgical instrument or operating a surgical tool. The recommendation can be an indication of an anatomical structure to operate on or to avoid. The recommendation can be related to administration of a particular treatment. The recommendation can be related to identification of a high-risk area or a potential complication (e.g., due to atypical anatomy). In some examples, the recommendation is provided during the surgery such that the surgeon can alter the course of action in real time.

In some examples, the enhanced fluorescence medical image can be provided (e.g., displayed) to a medical practitioner, who can review the image to identify, recommend, and/or administer a treatment or some other course of action to the patient pre-surgery, during surgery, or post-operatively. In some examples, the enhanced clarified image can be provided to a computer-based system, which processes the image to identify, recommend, and/or administer a treatment or some other course of action to the patient. For example, the system can provide the enhanced fluorescence medical image to a classification model to automatically identify one or more complications. Based on the identified issue, a treatment or some other course of action can be automatically recommended (e.g., via one or more graphical user interfaces). The treatment can also be automatically administered, for example, by a medical device (e.g., a surgical robot) based on the automatically recommended treatment.

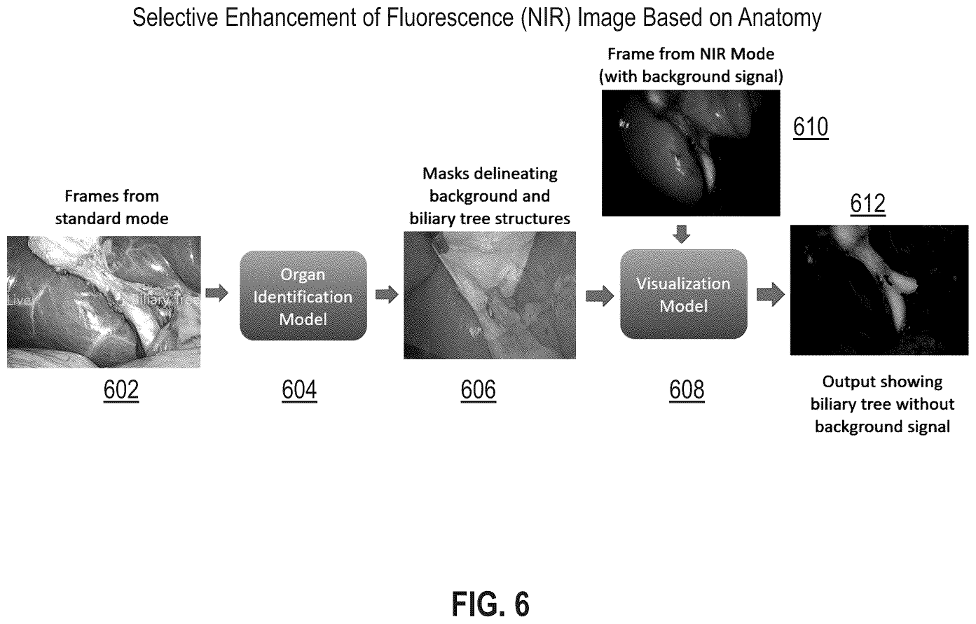

FIG. 6 illustrates an exemplary process of selective enhancement of fluorescence (NIR) images based on anatomy, in accordance with some examples. With reference to FIG. 6, a visible-light image 602 is inputted into an organ identification model 604, which may include the one or more machine-learning models described above with reference to FIG. 5. In the depicted example, the organ identification model 604 outputs one or more masks 606 delineating background and biliary tree structures depicted in the visible-light image 602 using the techniques described herein. A visualization model 608 can receive the one or more masks 606 and a fluorescence image 610, which provides an identical operative view as the visible-light image 602 and includes background signals that interfere with the visibility of the biliary tree structures in the image 610. The visualization model 608 can output an enhanced fluorescence image 612, using the masks 606 to selectively suppress background signals (e.g., pixels corresponding to liver) and/or selectively boost the signals from the area of interest (i.e., the biliary tree). For example, the visualization model 608 may reduce the background signals by multiplying the corresponding pixels with 0. Accordingly, the organ identification model and the visualization model effectively eliminate the need for manual tuning of cut-off threshold and make dissection of the Calot's triangle smooth, easy, and safe.

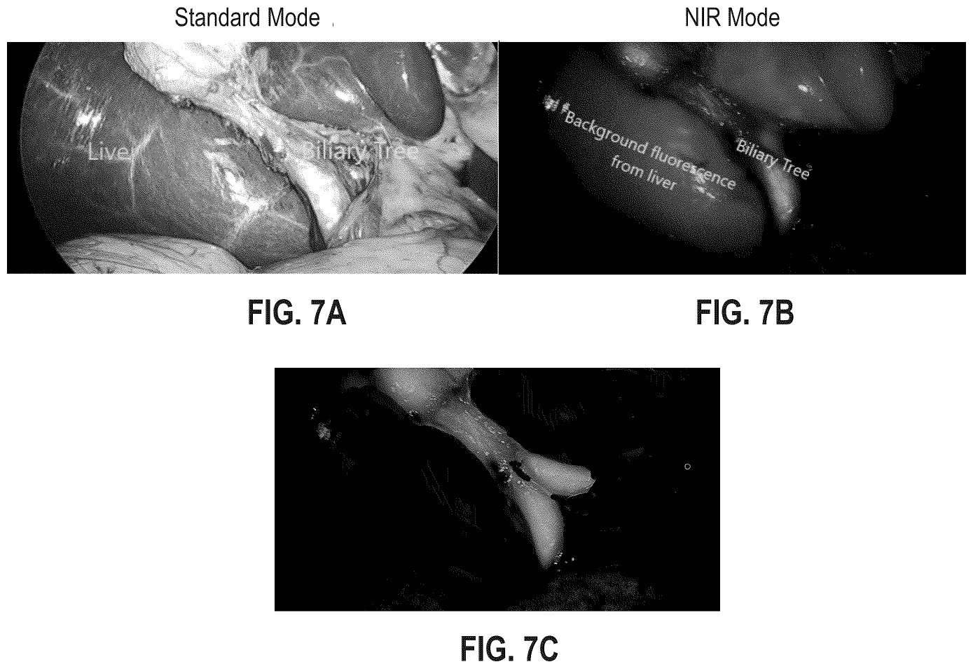

FIGS. 7A-C illustrate how techniques described herein can be used to enhance an exemplary fluorescence medical image captured during a laparoscopic cholecystectomy surgery, in accordance with some examples. FIG. 7B is the exemplary fluorescence medical image and FIG. 7C is the enhanced version. FIG. 7C is obtained based on the corresponding visible-light image (FIG. 7A) using the techniques described herein. In FIG. 7C, the unwanted background fluorescence signals from liver tissue are suppressed and the fluorescence signals from the biliary structures are boosted.

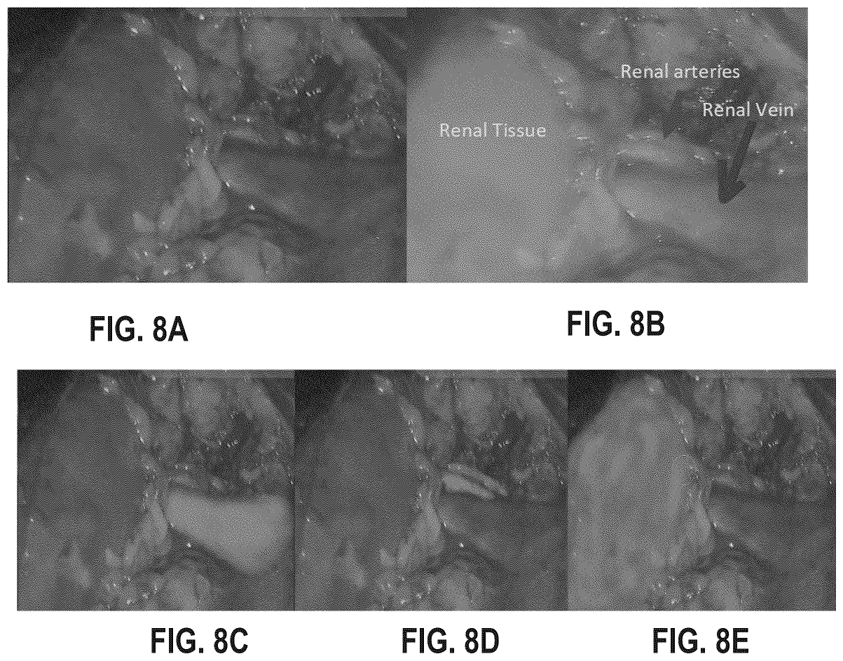

FIGS. 8A-E illustrate how techniques described herein can be used to enhance an exemplary fluorescence medical image captured during partial nephrectomies, in accordance with some examples. During partial nephrectomies, ICG can be used to identify the renal arteries and the renal vein, and to differentiate between the tumor and the normal renal tissue. When ICG is injected, the renal arteries, the renal vein, and the normal renal tissue may all emit fluorescence signals, as shown in FIG. 8B. By leveraging techniques described herein, a surgeon can choose to enhance the signals from one anatomical structure while suppressing the signals from other anatomical structures. In FIG. 8C, the ICG signals from the renal vein are enhanced; in FIG. 8D, the ICG signals from the renal artery are enhanced; in FIG. 8E, the ICG signals from the renal tissue are enhanced. The enhancement is performed using the visible-light image FIG. 8A using techniques described herein.

In some examples, techniques described herein can be used to enhance fluorescence images during mastectomies with flap reconstruction. In mastectomies, ICG can be used twice. First, to identify the sentinel lymph node, ICG can be injected locally at the tumor site. Then during flap reconstruction, ICG can be injected systemically to assess the perfusion. The fluorescence signals from the local injection may remain during the perfusion assessment causing background signals. Techniques described herein may be used to suppress the background signals due to local injection of ICG and enhance the signals from ICG injected through systemic circulation.

In some examples, a fluorescence medical image of a subject may additionally, or alternatively, be enhanced based on a background area identified in the fluorescence image using one or more machine-learning models, as described below. In some examples, a fluorescence image and/or visible-light image may be captured on the same scene and input into one or more machine learning models in parallel to identify a background area and/or one or more objects of interest based one either or both of the fluorescence image and/or visible-light image. In some examples, the background area and/or objects of interest in the fluorescence image may be identified by the one or more machine learning models based on fluorescent patterns identified by the one or more machine learning models corresponding to cellular structures and/or shapes of organs and/or tissues depicted in the fluorescence image.

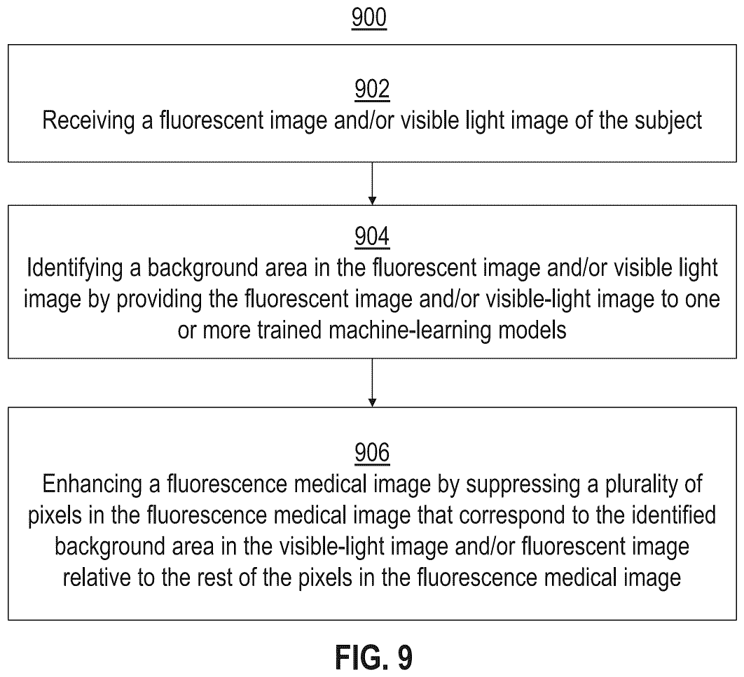

FIG. 9 illustrates an exemplary method 900 for enhancing a fluorescence medical image of a subject, according to some examples. In some examples, the fluorescence medical image may be an autofluorescence image. Process 900 is performed, for example, using one or more electronic devices implementing a software platform. In some examples, process 900 is performed using a client-server system, and the blocks of process 900 are divided up in any manner between the server and one or more client devices. In some examples, process 900 is performed using only a client device or only multiple client devices. In process 900, some blocks are, optionally, combined, the order of some blocks is, optionally, changed, and some blocks are, optionally, omitted. In some examples, additional steps may be performed in combination with the process 900. Accordingly, the operations as illustrated (and described in greater detail below) are exemplary by nature and, as such, should not be viewed as limiting.

At block 902, an exemplary system receives a fluorescence image (e.g., NIR image, UV image) of a subject. In some examples, the fluorescence image is captured during a surgery. In some examples, a visible-light image is captured in the same surgery and/or around the same time as the fluorescence image to be enhanced. In some examples, the visible-light image and the fluorescence image are captured with the same camera with different illumination sources and captured on one or more image channels (e.g., white-light channel(s) v. fluorescence channel(s)); accordingly, the two images depict an identical scene. In some examples, the visible-light image and/or the fluorescence image are sampled from one or more intraoperative videos.

The surgery during which the visible-light image and/or the fluorescence image are captured may include any surgical procedure, including endoscopic procedures and open field procedures. In some examples, the surgery includes: a laparoscopic cholecystectomy surgery, a colorectal resection surgery, a total thyroidectomy surgery, a mastectomy surgery, a laparoscopic nephrectomy surgery, a laparoscopic liver resection surgery, a video assisted thoracoscopic surgery (VATS), a cystoscopy, a ureteroscopy, a transurethral resection of bladder tumor (TURBT), or a transurethral resection of the prostate (TURP).

At block 904, the system identifies a background area and/or one or more objects of interest in the fluorescence image by providing the fluorescence image to one or more trained machine learning models. The machine-learning models may include one or more machine-learning models configured to identify one or more background objects in the input image, one or more machine-learning models configured to identify one or more areas or objects of interest in the input image, or any combination thereof, as discussed below.

The system can provide the fluorescence image to one or more trained machine-learning models configured to identify one or more background objects in an input image. The background objects may be surgery-dependent and include objects in the image that are not of interest to the user (e.g., a surgeon) and therefore should be suppressed relative to the objects of interest depicted in the image. In some examples, the one or more background objects can comprise: an organ, a blood vessel, a connective tissue, a non-tumorous tissue, or fat.

Alternatively, or additionally, the system can provide the fluorescence image to one or more trained machine-learning models configured to identify one or more objects of interest in an input image. The objects of interest may be surgery-dependent and include objects in the image that are useful/important to the user (e.g., a surgeon) and therefore should be made more visually distinguishable. In some examples, the one or more objects of interest can comprise: a biliary structure, a tumor, an anastomotic end, a parathyroid gland, a lymph node, a limb drainage node, a thoracic duct, a renal vein, an artery, a ureter, a dysplastic tissue, a metaplastic tissue, or any combination thereof.

The one or more machine-learning models can include a model that is configured to detect a single object (e.g., a single background object, a single object of interest), a model that is configured to detect multiple objects (e.g., background object(s), object(s) of interest, or a combination thereof), or a combination thereof. As one example, an exemplary machine-learning model can be trained to detect a single predefined background object. The model receives an input image and identifies the pixels in the image that correspond to the background object. The model may assign a first value (e.g., 1) to those identified pixels while assigning a second value (e.g., 0) to the rest of the pixels. As a second example, an exemplary machine-learning model can be trained to detect multiple predefined objects. The model receives an input image and identifies the pixels in the image that correspond to those objects. The model may assign a first value (e.g., 1) to those identified pixels while assigning a second value (e.g., 0) to the rest of the pixels. Alternatively, the model may assign different integer values to different objects. For example, the model may assign a first value (e.g., 1) to pixels corresponding to a first object, a second value (e.g., 2) to pixels corresponding to a second object, . . . while assigning a different value (e.g., 0) to the pixels that do not correspond to any identified object in the image.

Based on the detected background objects (which are part of the background area) and/or the detected objects of interest, the system can obtain a pixel-wise mask indicative of the identified background area. For example, the pixel-wise mask can comprise a plurality of binary values, each binary value corresponding to a pixel in the fluorescence image and indicative of whether the corresponding pixel depicts background or not (e.g., 0 representing the background and non-zero representing non-background). As another example, the pixel-wise mask can comprise a plurality of integer values, each integer value corresponding to a pixel in the fluorescence image and indicative of an object that the corresponding pixel depicts (e.g., 1 representing a first object, 2 representing a second object, etc.).

In some examples, the one or more trained machine-learning models are selected based on the surgery during which the fluorescence image is taken. Different surgeries may involve different objects of interest. For example, a blood vessel may be considered an object of interest to be enhanced in one surgery, but a background object to be suppressed in a different surgery. Accordingly, depending on the surgery and/or surgeon preferences, the system can select different model(s) based on what is considered to be background in the context of that surgery.

The machine-learning models may comprise any machine-learning models that can be configured to detect an object in an input image. In some examples, the machine-learning models can comprise a binary and or multi-class semantic segmentation model, a panoptic semantic segmentation model, regression model for predicting contours of objects, dense semantic regression model for predicting pixel-wise level or fluorescence modulation, an object detection model detecting object contours, or any combination thereof. In some examples, the machine-learning models can comprise convolutional neural networks (CNNs), recurrent neural networks (RNNs), diffusion models, transformer networks, reinforcement learning or any combination thereof. In some examples, the models can be based on any of the deep learning architectures such as CNNs, region-based CNNs (R-CNNs), pyramidal pooling or long short-term memory (LSTM) models, transformers, or any combination thereof.

The machine-learning models can be trained using a plurality of training images. The training images may include one or more annotations related to a background object/area or an object/area of interest. In one or more of the training images, at least a portion of the image (e.g., a group of pixels) can be annotated (e.g., labeled, marked) as corresponding to a specific organ, tissue, and/or tissue type. In one or more of the training images, one, some, or all of the pixels may be annotated as corresponding to a specific organ, tissue, and/or tissue type. In one or more of the training images, the annotated portion of the image can depict one or more patterns. In some examples the one or more patterns are associated with a microstructure of a tissue, tissue type, and/or organ. In some examples the microstructure is a cellular structure or shape of the tissue, tissue type, and/or organ. In some examples the one or more patterns include a tubular pattern, a lobular pattern, or any combination thereof. A fluorescent agent introduced into the body may conform to the cellular structures or shapes of respective organs, tissues, and/or tissue types. The model can thus be trained to recognize a specific organ, tissue, and/or tissue type by detecting unique fluorescence pattern associated with that organ, tissue, and/or tissue type. During training, a model can be configured to receive a training image and identify pixels corresponding to an object. The pixels can be compared against the annotations (i.e., the ground truth), and the model can be updated based on the comparison. In some examples, the models may be pre-trained using a first training dataset and then fine-tuned using a second training dataset. In some examples, the models may be fine-tuned periodically or on an ongoing basis using new training datasets.

In some examples, the machine-learning models include a single model trained to detect a plurality of different objects (e.g., trained to detect multiple different tissues, tissue types, organs, or other observable objects). For example, a single model may be trained to detect liver tissue, bile duct tissue, biliary tree tissue, and so on. In some examples, the machine learning models include multiple models, each model trained to detect a single type of object (e.g., trained to detect a specific tissue, tissue type, organ, or other observable object). For instance, a first model may be trained to detect a liver and a second model may be trained to detect a bile duct. In some examples, a single machine learning model may include multiple modules, each module trained to detect a specific tissue, tissue type, organ, or other observable object.

At block 906, the system enhances the fluorescence medical image. Specifically, the system can suppress a plurality of pixels in the fluorescence medical image that correspond to the identified background area in the fluorescence image relative to the rest of the pixels in the fluorescence medical image. The system can do so by, for example, reducing the amplitude of those pixels corresponding to the identified background area. The reduction can be done by multiplying the amplitude of each pixel with 0 or a value lower than 1. Alternatively, or additionally, the system can do so by boosting the pixels that do not correspond to the identified background area (e.g., the pixels corresponding to the objects of interest). The boosting can be done by multiplying the amplitude of each pixel with a value higher than 1, by applying a gain function, or a combination thereof, to make the pixel appear more visually distinguishable (e.g., brighter).

The system may allow a user (e.g., a surgeon) to indicate the degree of enhancement (e.g., a percentage). For example, the system can provide a user interface control (e.g., a slide bar, a text field, a button, a checkbox) for the user to indicate the desired degree of enhancement. Based on the input, the system can then suppress the plurality of pixels in the fluorescence medical image that correspond to the identified background area in the fluorescence image relative to the rest of the pixels in the fluorescence medical image (e.g., by reducing amplitude of the background pixels, by increasing amplitude of pixels corresponding to the area of interest, or both).

The system may also allow a user to indicate which background object(s) to suppress and/or which object(s) of interest to boost. For example, the system can display the fluorescence image, indicate the identified objects in the fluorescence image (e.g., via shadings, via contours), and provide a user interface control (e.g., a slide bar, a text field, a button, a checkbox) for the user to select an object to suppress or boost.

After the fluorescence medical image is enhanced, the system can display the enhanced fluorescence medical image. For example, the system can display the enhanced fluorescence medical image as a part of an intraoperative video stream (e.g., in real time or with minimal delay). The system can display the visible-light image and display the enhanced fluorescence medical image as an overlay on the displayed visible-light image. In some examples, the system may display only the organ or tissue or other object of interest (e.g., the non-suppressed area of the image, and/or the boosted area of the image) as the overlay. In some examples, the system can extract the luminance channel of the visible-light image, colorize the luminance channel of the visible-light image based on the enhanced fluorescence medical image; and display the colorized luminance channel of the visible-light image. In some examples, fluorescence signal from different organs or different tissues can be enhanced with different colors.

In some examples, the system can provide a recommendation related to the surgical procedure based on the enhanced fluorescence medical image. The recommendation can be related to navigating a surgical instrument or operating a surgical tool. The recommendation can be an indication of an anatomical structure to operate on or to avoid. The recommendation can be related to administration of a particular treatment. The recommendation can be related to identification of a high-risk area or a potential complication (e.g., due to atypical anatomy). In some examples, the recommendation is provided during the surgery such that the surgeon can alter the course of action in real time.

In some examples, the enhanced fluorescence medical image can be provided (e.g., displayed) to a medical practitioner, who can review the image to identify, recommend, and/or administer a treatment or some other course of action to the patient pre-surgery, during surgery, or post-operatively. In some examples, the enhanced clarified image can be provided to a computer-based system, which processes the image to identify, recommend, and/or administer a treatment or some other course of action to the patient. For example, the system can provide the enhanced fluorescence medical image to a classification model to automatically identify one or more complications. Based on the identified issue, a treatment or some other course of action can be automatically recommended (e.g., via one or more graphical user interfaces). The treatment can also be automatically administered, for example, by a medical device (e.g., a surgical robot) based on the automatically recommended treatment.

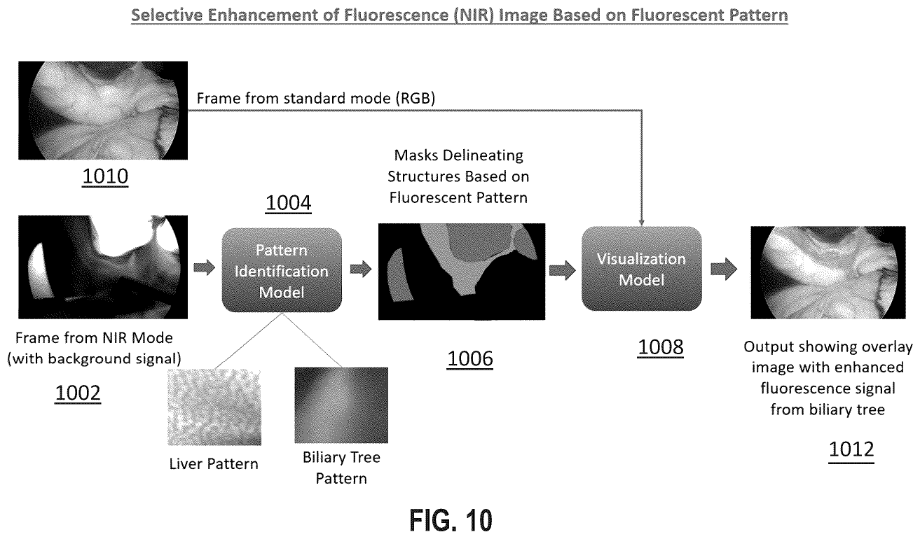

FIG. 10. illustrates an exemplary process of selective enhancement of fluorescence (NIR) images based on machine learning analysis of fluorescence images, in accordance with some examples. With reference to FIG. 10, a fluorescence (NIR) image 1002 is inputted into a pattern identification model 1004, which may include the one or more machine-learning models described above with reference to FIG. 9. In the depicted example, the pattern identification model 1004 outputs one or more masks 1006 delineating background, liver, and biliary tree structures depicted in the fluorescence image 1002. A visualization model 1008 can receive the one or more masks 1006 and a visible-light image 1010, which provides an identical operative view as the fluorescence image 1002.

The visualization model 1008 can enhance fluorescence image 1002, using the masks 606 to selectively suppress background signals (e.g., pixels corresponding to liver) and/or selectively boost the signals from the area of interest (i.e., the biliary tree). The visualization model 1008 can output one or both of the enhanced fluorescence image and the visible-light image with an overlay on the visible-light image indicating an enhanced or suppressed fluorescence signal associated with an object of interest (e.g., liver, biliary tree) or background area. For example, the visualization model 1008 may reduce the background signals of the fluorescence image by multiplying the corresponding pixels with 0.

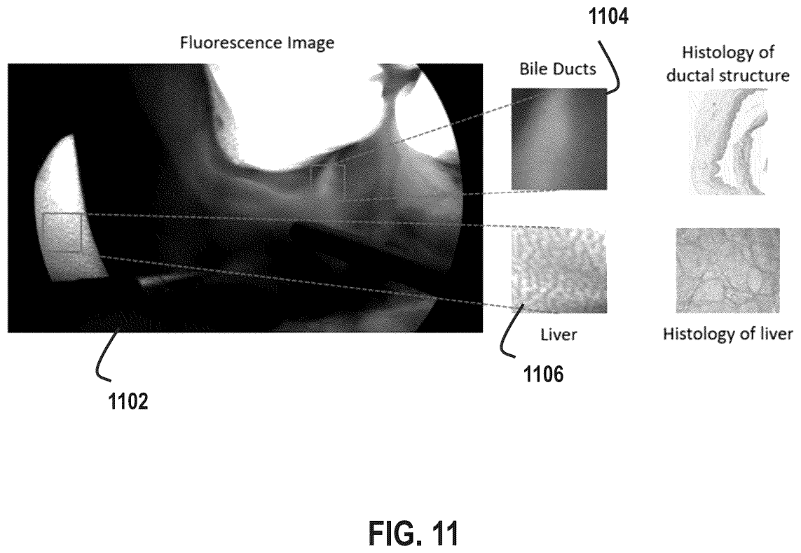

FIG. 11 illustrates different patterns that may be associated with different tissues, organs, and/or tissue types. As depicted in FIG. 11, a fluorescence image 1102 may include at least a portion of the liver and at least a portion of a bile duct. The liver may include a lobular patterned cellular structure. The bile duct may include a tubular patterned cellular structure. The one or more machine learning models described herein may be trained to distinguish between different organs and/or tissues based on a cellular pattern or other micro-structural pattern of the tissue, as described above. In some examples, the entire training image 1102 may be input into the one or more machine learning models during training. At least a portion (e.g., a group of pixels) of training image 1102 may be annotated/labeled (e.g., a portion corresponding to a specific organ, tissue, and/or tissue type). In some examples, a cropped portion of the training image 1102 may be input into the one or more machine learning models during training. For instance, a cropped portion 1104 that depicts a bile duct and/or a cropped portion 1106 that depicts a liver may be input into the one or more machine learning models. The cropped portion 1104 may be annotated according to the organ, tissue, tissue type, fluorescence pattern, microstructure of a tissue, or other observable characteristic depicted in cropped portion 1104 and the annotation may be input into the one or more machine learning models during training as described above. The cropped portion 1106 may similarly be annotated according to the organ, tissue, tissue type, fluorescence pattern, microstructure of a tissue, or other observable characteristic depicted in cropped portion 1106 and the annotation may be input into the one or more machine learning models during training as described above.

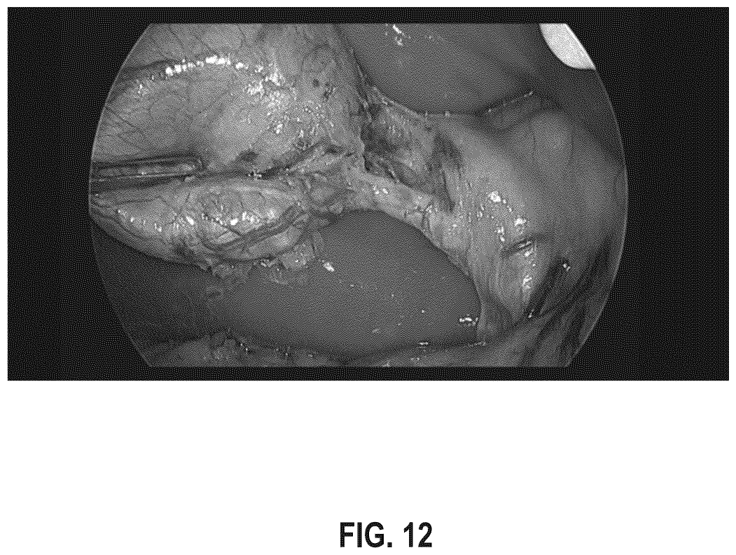

The systems described herein may be configured to display enhanced fluorescence images and/or visible light images modified based on the enhanced fluorescence images (e.g., output 1012 of FIG. 10). In some examples, the system may be configured to display an enhanced fluorescence image depicting different organs, tissues, and/or tissue types enhanced with different colors. In some examples, the system may be configured to display an enhanced fluorescence image (or portion thereof) overlayed on a visible-light image. In some examples, the overlay depicts different organs, tissues, and/or tissue types enhanced with different colors. In some examples, the system may be configured to display a visible light image. The system may display one or more different organs, tissues, and/or tissue types in the visible-light image using different colors. For instance, a system may be configured to extract the luminance channel of the visible-light image, colorize the luminance channel of the visible-light image based on the enhanced fluorescence medical image, and display the colorized luminance channel of the visible-light image. Displaying the colorized luminance channel of the visible-light image may include displaying a first color on a first organ or tissue and displaying a second color on a second organ or tissue. The displayed colors may correspond to a region of fluorescence signal associated with a respective organ or tissue. FIG. 12 illustrates an example of a visible light image in which different colors are displayed on different organs. Specifically, in FIG. 12, the liver fluorescence is shown in red, gall bladder fluorescence is shown in blue and biliary tract fluorescence is shown in orange. Color coding different organs and/or tissues or tissue types enables physicians to distinguish between the respective organs and/or tissues during a surgical procedure.

The foregoing description, for the purpose of explanation, has been described with reference to specific examples or aspects. However, the illustrative discussions above are not intended to be exhaustive or to limit the invention to the precise forms disclosed. For the purpose of clarity and a concise description, features are described herein as part of the same or separate variations; however, it will be appreciated that the scope of the disclosure includes variations having combinations of all or some of the features described. Many modifications and variations are possible in view of the above teachings. The variations were chosen and described in order to best explain the principles of the techniques and their practical applications. Others skilled in the art are thereby enabled to best utilize the techniques and various variations with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

What is claimed is:

1. A method of enhancing a fluorescence medical image of a subject, comprising:
receiving a visible-light image and the fluorescence medical image of the subject;
identifying a background area in at least one of the visible-light image and the fluorescence medical image by providing at least one of the visible-light image and the fluorescence medical image to one or more trained machine-learning models; and
enhancing the fluorescence medical image by suppressing a plurality of pixels in the fluorescence medical image that correspond to the identified background area in at least one of the visible-light image and the fluorescence medical image relative to the rest of the pixels in the fluorescence medical image.

2. The method of claim 1, further comprising displaying the enhanced fluorescence medical image.

3. The method of claim 2, wherein displaying the enhanced fluorescence medical image comprises: displaying the enhanced fluorescence medical image as a part of an intraoperative video stream.

4. The method of claim 1, further comprising:
displaying the visible-light image; and
displaying the enhanced fluorescence medical image as an overlay on the displayed visible-light image.

5. The method of claim 1, further comprising:
extracting the luminance channel of the visible-light image;
colorizing the luminance channel of the visible-light image based on the enhanced fluorescence medical image; and
displaying the colorized luminance channel of the visible-light image.

6. The method of claim 5, wherein displaying the colorized luminance channel of the visible-light image comprises displaying a first color for a first organ or tissue and displaying a second color for a second organ or tissue.

7. The method of claim 1, further comprising:
receiving a first user input indicative of a degree of enhancement; and
suppressing the plurality of pixels in the fluorescence medical image based on the first user input.

8. The method of claim 1, wherein identifying the background area comprises:
identifying one or more background objects in the visible-light image by providing the visible-light image to the one or more trained machine-learning models.

9. The method of claim 1, wherein identifying the background area comprises: identifying one or more background objects in the fluorescence image by providing the fluorescence image to the one or more trained machine learning models.

10. The method of claim 9, wherein the one or more background objects comprise: an organ, a blood vessel, a connective tissue, a non-tumorous tissue, or fat.

11. The method of claim 9, further comprising:
receiving a second user input indicative of a selection of a background object of the one or more background objects; and
suppressing the plurality of pixels in the fluorescence medical image based on the second user input.

12. The method of claim 1, wherein identifying the background area comprises:
identifying one or more objects of interest in the visible-light image by providing the visible-light image to the one or more trained machine-learning models.

13. The method of claim 1, wherein identifying the background area comprises: identifying one or more objects of interest in the fluorescence image by providing the fluorescence image to the one or more trained machine learning models.

14. The method of claim 13, wherein the one or more objects of interest comprise: a biliary structure, a tumor, an anastomotic end, a parathyroid gland, a lymph node, a limb drainage node, a thoracic duct, a renal vein, an artery, a ureter, a dysplastic tissue, a metaplastic tissue, or any combination thereof.

15. The method of claim 13, further comprising:
enhancing the fluorescence medical image by boosting a plurality of pixels in the fluorescence medical image that correspond to the one or more objects of interest in the visible-light image.

16. The method of claim 1, wherein the trained machine-learning model is configured to output a pixel-wise mask indicative of the identified background area.

17. The method of claim 16, wherein the pixel-wise mask comprises a plurality of binary values, each binary value corresponding to a pixel in at least one of the visible-light image and the fluorescence medical image and indicative of whether the corresponding pixel depicts background or not.

18. The method of claim 16, wherein the pixel-wise mask comprises a plurality of integer values, each integer value corresponding to a pixel in at least one of the visible-light image and the fluorescence medical image and indicative of an object that the corresponding pixel depicts.

19. The method of claim 1, wherein the visible-light image and the fluorescence image have been captured during a surgery.

20. The method of claim 19, wherein the surgery comprises: a laparoscopic cholecystectomy surgery, a colorectal resection surgery, a total thyroidectomy surgery, a mastectomy surgery, a laparoscopic nephrectomy surgery, a laparoscopic liver resection surgery, a video assisted thoracoscopic surgery (VATS), a cystoscopy, a ureteroscopy, a transurethral resection of bladder tumor (TURBT), or a transurethral resection of the prostate (TURP).

21. The method of claim 1, wherein the visible-light image and the fluorescence image are sampled from one or more intraoperative videos.

22. The method of claim 1, wherein the one or more trained machine-learning models are selected based on the surgery.

23. The method of claim 1, wherein the visible-light image and the fluorescence image have been captured using the same camera with different filters.

24. The method of claim 1, wherein the one or more trained machine-learning models comprise a convolutional neural network (CNN), a recurrent neural network (RNN), a diffusion model, a transformer Network, or any combination thereof.

25. The method of claim 24, wherein the one or more machine-learning models are trained using a plurality of training images, each training image including one or more annotations related to a background object or an object of interest.

26. The method of claim 25, wherein at least a subset of the plurality of training images comprise one or more annotations related to a pattern associated with a microstructure of a tissue.

27. A system for enhancing a fluorescence medical image of a subject, comprising:
one or more processors;
one or more memories; and
one or more programs, wherein the one or more programs are stored in the one or more memories and configured to be executed by the one or more processors, the one or more programs including instructions for:
receiving a visible-light image of the subject and the fluorescence medical image of a subject;
identifying a background area in at least one of the visible-light image and the fluorescence medical image by providing at least one of the visible-light image and the fluorescence medical image to one or more trained machine-learning models; and
enhancing the fluorescence medical image by suppressing a plurality of pixels in the fluorescence medical image that correspond to the identified background area in at least one of the visible-light image and the fluorescence medical image relative to the rest of the pixels in the fluorescence medical image.

28. A non-transitory computer-readable storage medium storing one or more programs, the one or more programs comprising instructions, which when executed by one or more processors of an electronic device, cause the electronic device to:
receive a visible-light image of the subject and the fluorescence medical image of a subject;
identify a background area in at least one of the visible-light image and the fluorescence medical image by providing at least one of the visible-light image and the fluorescence medical image to one or more trained machine-learning models; and
enhance the fluorescence medical image by suppressing a plurality of pixels in the fluorescence medical image that correspond to the identified background area in at least one of the visible-light image and the fluorescence medical image relative to the rest of the pixels in the fluorescence medical image.
